(19) United States
(12) Patent Application Publication
(10) Pub. No.: US 2017/0103731 A1
(43) Pub. Date: Apr. 13, 2017

(54) SEAMLESS SWITCHING METHOD AND SYSTEM FOR MULTIPLE HOST COMPUTERS

(71) Applicant: Silicon Video Systems, Inc., Hsinchu County (TW)

(72) Inventor: Chih-Yuan Hsieh, Hsinchu County (TW)

(21) Appl. No.: 14/881,404

(22) Filed: Oct. 13, 2015

(51) Int. Cl. G09G 5/14; G06F 3/038; G09G 5/00; G06F 3/0354

(52) U.S. Cl. CPC G09G 5/14; G06F 3/03543; G06F 3/038; G09G 5/006; G09G 2354/00; G09G 2320/08

(57) ABSTRACT

In a method and a system, an operating interface is used to operate a multi-system platform. A single pointing device is used to operate first and second computer platforms on a display. The first and second computer platforms are operated under first operation system and second operation system, respectively. The display displays a main window frame displaying at least one of the first work desktop and the second work desktop, and appoints the first work desktop or the second work desktop as a work window by detecting a pointing position of the pointing device. Selecting of the work window is determined according to a direction in which the pointing position is moved to the first work desktop or the second work desktop, and according to the pointing position touching a boundary of the first or second work desktop.

### BACKGROUND OF THE INVENTION

(1) Field of the Invention

The present invention relates to the technical field of the computer control, and more particularly to a seamless switching method and a seamless switching system for switching between a first host computer and a second host computer using an input module, a display unit and a control module.

(2) Description of the Prior Art

Conventionally, methods for controlling a plurality of computer platforms (or a plurality of video input platforms) using a single keyboard or mouse comprise the following two methods.

In the first method, it is necessary to execute an application program to generate a user interface with multiple window frames, and then to click one of the windows to switch between the computer platforms or the video input platforms.

In the second method, the hardware switching is utilized. For example, a KVM is used to switch the display of each computer platform to the main screen to obtain one single window that can be controlled.

However, the above-mentioned methods are quite complicated and inconvenient for the user on either the operation or installation.

Thus, the present invention provides a seamless switching method and a seamless switching system for multiple host computers to solve the conventional drawbacks.

### SUMMARY OF THE INVENTION

A first object of the present invention is to provide a seamless switching method for multiple host computers and for operating a first computer platform and a second computer platform on at least one display unit using a single pointing device.

A second object of the present invention is achieved according to the seamless switching method for multiple host computers, wherein the input module generates a displacement signal and converts the displacement signal into a coordinate position.

A third object of the present invention is achieved according to the seamless switching method for multiple host computers, wherein the display unit displays at least one of first work desktop and second work desktop to switch between the first host computer and the second host computer according to at least one of first work-desktop-boundary and second work-desktop-boundary. A fourth object of the present invention is achieved according to the seamless switching method for multiple host computers, wherein it is determined to switch between the first host computer and the second host computer according to at least one of first work-desktop-boundary, second work-desktop-boundary, and a moving direction.

A fifth object of the present invention is achieved according to the seamless switching method for multiple host computers, wherein the single pointing device can be utilized to operate the first computer platform and the second computer platform on the display or an extended display thereof.

A sixth object of the present invention is achieved according to the seamless switching method for multiple host computers, wherein the display unit concurrently displays the first work desktop and the second work desktop in a picture-out-of-picture (POP) mode, or concurrently displays the first work desktop and the second work desktop in a picture-in-picture (PIP) mode, or the display unit displays the first work desktop or the second work desktop by way of triggering.

A seventh object of the present invention is to provide a seamless switching system for multiple host computers to implement the seamless switching method for multiple host computers.

To achieve the above-identified and other objects, the present invention provides to a seamless switching method for multiple host computers, it can switch between a first host computer and a second host computer using an input module, a display unit and a control module. The first host computer can be operated under a first work desktop and the second host computer can be operated under a second work desktop. The seamless switching method comprises: (a) generating a displacement signal by the input module; (b) converting the displacement signal into a coordinate position by the control module; (c) displaying the first work desktop and the second work desktop by the display unit, wherein the first work desktop is located at a first direction of the second work desktop, and the second work desktop is located at a second direction of the first work desktop; (d) positioning a relative coordinate position on the first work desktop according to the coordinate position by the first host computer, wherein the first work desktop has at least one first work-desktop-boundary; (e) judging that the coordinate position falls within a first boundary coordinate range of the first work-desktop-boundary and the coordinate position moves from the first boundary coordinate range in a direction toward the second work desktop to determine to switch from the first host computer to the second host computer; (f) positioning a relative coordinate position on the second work desktop according to the coordinate position by the second host computer, wherein the second work desktop has at least one second work-desktop-boundary; and (g) judging that the coordinate position falls within a second boundary coordinate range of the second work-desktop-boundary and the coordinate position moves from the second boundary coordinate range in a direction toward the first work desktop to determine to switch from the second host computer to the first host computer.

To achieve the above-identified and other objects, the present invention provides a seamless switching system for multiple host computers. The seamless switching system is to be combined with a display unit to switch between a first host computer and a second host computer. The first host computer can be operated under a first work desktop and the second host computer can be operated under a second work desktop. The first work desktop has at least one first work-desktop-boundary. The second work desktop has at least one second work-desktop-boundary. The seamless switching system for multiple host computers comprises a control module, an input module, an image module and an expansion module. The input module is connected to the control module and generates a displacement signal. The image module is connected to the control module and to be connected to at least one of the display unit, the first host computer and the second host computer to make the display unit display at least one of the first work desktop and the second work desktop. The expansion module is connected to the control module, and is to be connected to the first host computer and the second host computer. The control module selects to convert the displacement signal into a coordinate position, and transmits the coordinate position to at least one of the first host computer and the second host computer. The control module judges that the coordinate position falls within a first boundary coordinate range relative to the first work-desktop-boundary and that the coordinate position moves from the first boundary coordinate range in a direction toward the second work desktop to determine to switch from the first host computer to the second host computer, or the control module judges that the coordinate position falls within a second boundary coordinate range relative to the second work-desktop-boundary and that the coordinate position moves from the second boundary coordinate range in a direction toward the first work desktop to determine to switch from the second host computer to the first host computer.

Compared with the prior art, the seamless switching method and system for multiple host computers according to the present invention can utilize a single display (or a plurality of displays, such as extended screens) to operate the host computers through a plurality of work desktops without executing any application program on the host computers. For example, in the present invention, the host computers utilize, for example, the operations of one set of keyboard and mouse according to the system of the present invention, so that it is determined to switch and control between the host computers by moving the cursor of the mouse between the work desktops according to the boundary coordinate and the moving direction.

In addition to the utilization of the mouse keyboard, the present invention further can directly operate each of the host computers on the work desktop by way of touching to click (or select) the work window.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic flow chart showing a seamless switching method for multiple host computers according to a first embodiment of the present invention.

FIGS. 2(a) to 2(c) are schematic views showing display contents on display units corresponding to FIG. 1.

FIG. 3 is a schematic view showing states in a seamless switching method for multiple host computers according to a second embodiment of the present invention.

FIG. 4 is a schematic block diagram showing a seamless switching system for multiple host computers according to a third embodiment of the present invention.

FIG. 5 is a schematic block diagram showing a seamless switching system for multiple host computers according to a fourth embodiment of the present invention.

### DETAILED DESCRIPTION OF THE PREFERRED EMBODIMENTS

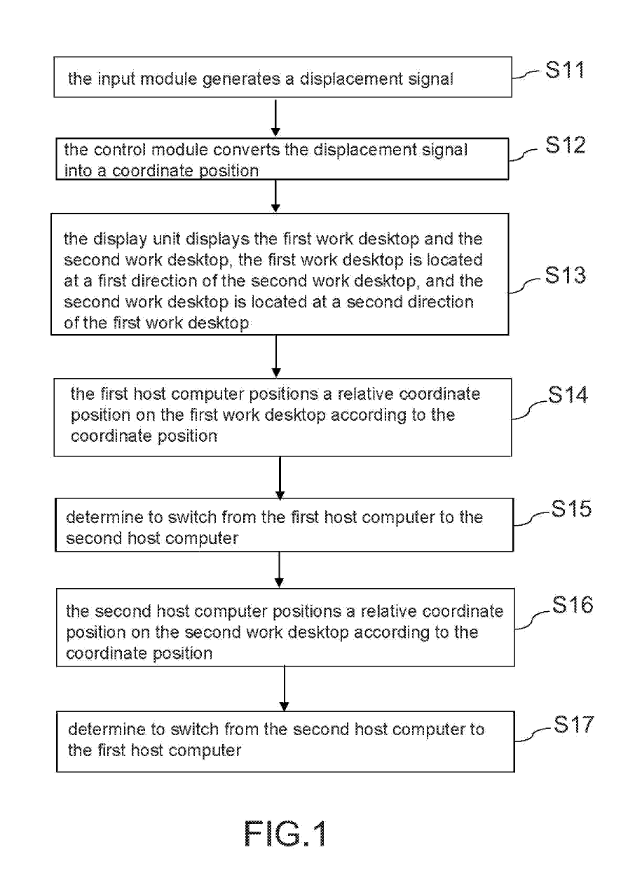

FIG. 1 is a schematic flow chart showing a seamless switching method for multiple host computers according to a first embodiment of the present invention. Referring to FIG. 1 showing the method of operating the multi-system platform using the window interface, the switching between a first host computer and a second host computer can be performed using an input module, a display unit and a control module. The first host computer is operated under a first work desktop, while the second host computer is operated under a second work desktop. In other words, the first host computer and the second host computer is operating independently.

The seamless switching method for multiple host computers includes the following steps. In the starting step S11, the input module generates a displacement signal.

In step 312, the control module converts the displacement signal into a coordinate position.

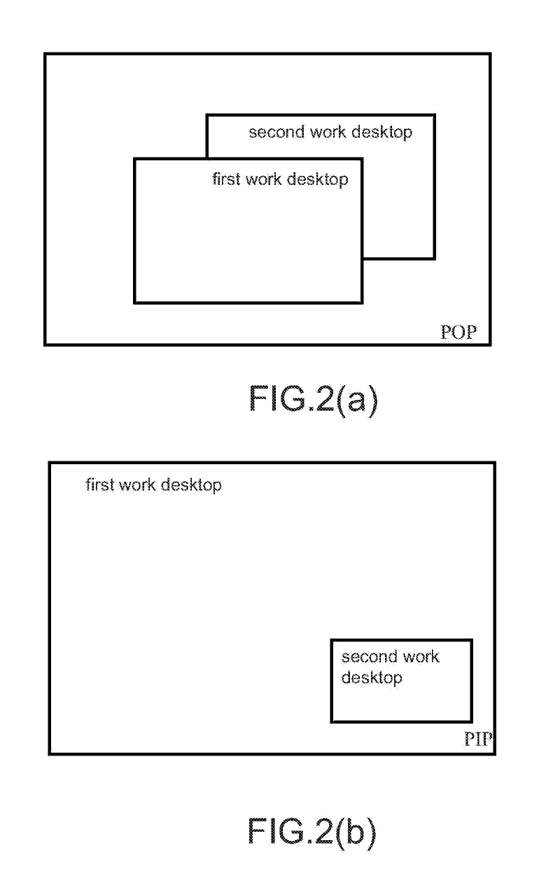

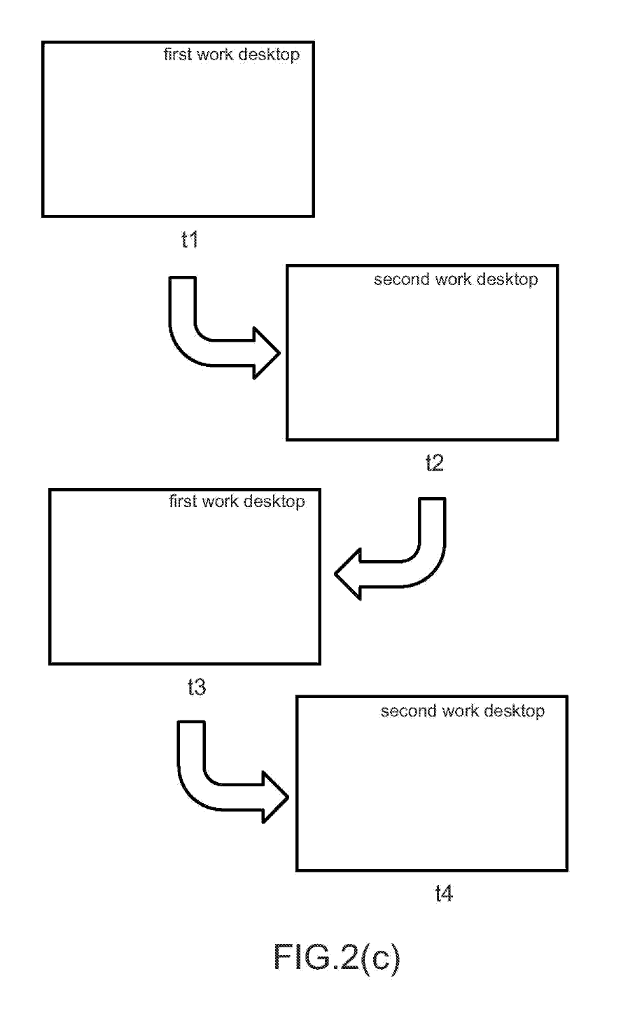

In step S13, the display unit displays the first work desktop and the second work desktop. The first work desktop is located at a first direction of the second work desktop, and the second work desktop is located at a second direction of the first work desktop. For example, in FIGS. 2(a) to 2(c), in another embodiment, the display unit may concurrently display the first work desktop and the second work desktop in a picture-out-of-picture (POP) mode, as shown in FIG. 2(a); the display unit may concurrently display the first work desktop and the second work desktop in a picture-in-picture (PIP) mode, as shown in FIG. 2(b); or the display unit may display the first work desktop or the second work desktop by way of triggering, as shown in FIG. 2(c). For example, at time t1, the display unit displays the first work desktop; at time t2, the display unit displays the second work desktop by way of triggering; at time t3, the display unit further displays the first work desktop further by way of triggering; and at time t4, the display unit further displays the second work desktop by way of triggering, and so on. Thus, the switching between the first work desktop and the second work desktop can be performed by way of triggering.

In step S14, the first host computer positions a relative coordinate position on the first work desktop according to the coordinate position, wherein the first work desktop has at least one first work-desktop-boundary.

In step 315, it is judged that the coordinate position falls within a first boundary coordinate range of the first work-desktop-boundary and that the coordinate position moves from the first boundary coordinate range in a direction toward the second work desktop to determine to switch from the first host computer to the second host computer.

In step S16, the second host computer positions a relative coordinate position on the second work desktop according to the coordinate position, wherein the second work desktop has at least one second work-desktop-boundary.

In step S17, it is judged that the coordinate position falls within a second boundary coordinate range of the second work-desktop-boundary and that the coordinate position moves from the second boundary coordinate range in a direction toward the first work desktop to determine to switch from the second host computer to the first host computer.

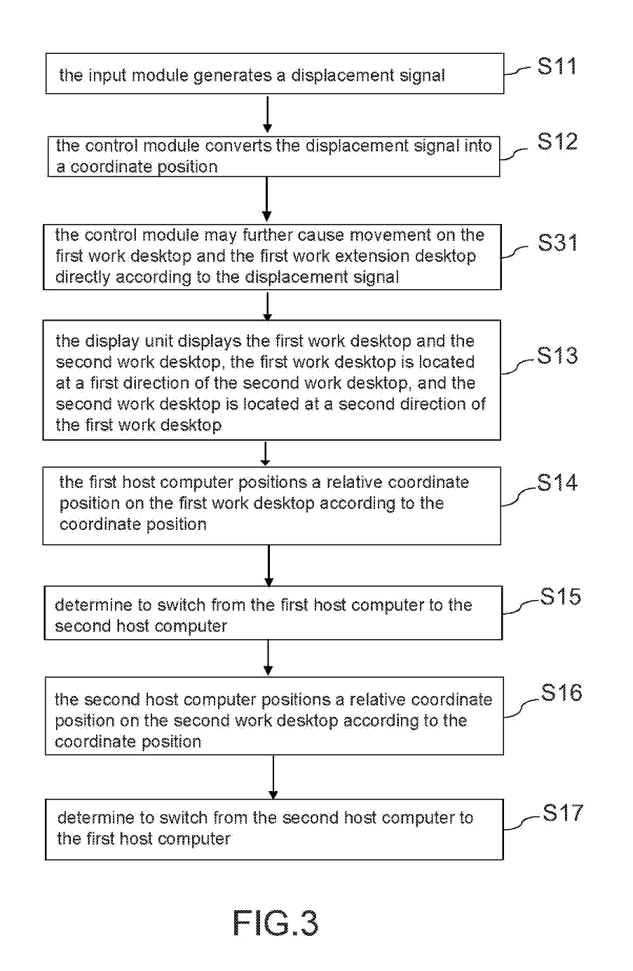

FIG. 3 is a schematic view showing states in a seamless switching method for multiple host computers according to a second embodiment of the present invention. In FIG. 3, in addition to operating on the first work desktop, the first host computer further operates on a first work extension desktop, the display displays the first work desktop, and an extended screen unit displays the first work extension desktop. Thus, the steps of FIG. 3 comprise the steps S11 to S17 of the first embodiment, and further comprise step S31.

The step S31 is a continuation of the step S12. In the step S31, the control module may further cause movement on the first work desktop and the first work extension desktop directly according to the displacement signal. In other words, the control module may select to cause movement between the work desktop and the extension desktop on the same host computer according to the displacement signal, or may determine to switch between the host computers according to the coordinate position.

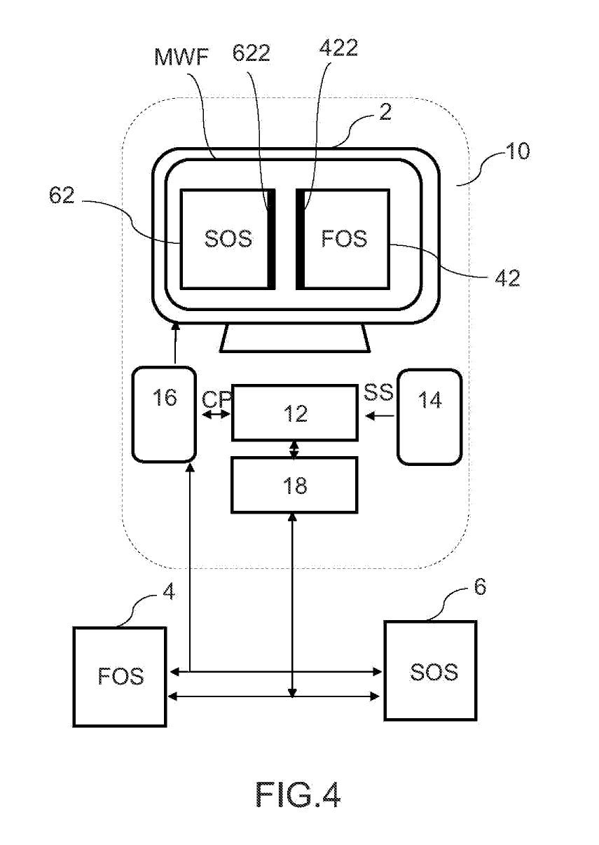

FIG. 4 is a schematic block diagram showing a seamless switching system for multiple host computers according to a third embodiment of the present invention. In FIG. 4, a seamless switching system 10 for host computers can work in conjunction with a display unit 2 to switch between a first host computer 4 and a second host computer 6, wherein the first host computer 4 is operated under a first work desktop 42, and the second host computer 6 is operated under a second work desktop 62. The first work desktop 42 comprises at least one first work-desktop-boundary 422, and the second work desktop 62 comprises at least one second work-desktop-boundary 622, wherein the first work-desktop-boundary 422 and the second work-desktop-boundary 622 are shown in a main window frame MWF. The first host computer 4 is operated under a first operation system FOS, and the second host computer 6 is operated under a second operation system SOS.

The seamless switching system 10 for the host computers comprises a control module 12, an input module 14, an image module 16 and an expansion module 18.

The input module 14 is connected to the control module 12. For example, the input module 14 is at least one of a mouse, a keyboard, a touch pen and a touch panel. The input module 14 generates a displacement signal SS.

The image module 16 is connected to the control module 12. For example, the image module 16 is the high definition multimedia interface (HDMI), BNC, D-SUB, VGA, color difference terminal, S-terminal, AV terminal, DVI, D-Terminal, RCA terminal, F terminal, RF terminal, DisplayPort, Thunderbolt or Lightning bolt. The image module 16 is connected to the display unit 2, the first host computer 4 and the second host computer 6, so that the display unit 2 displays at least one of the first work desktop 42 and the second work desktop 62. In another embodiment, the display unit displays the first work desktop 42 and the second work desktop 62 in the POP mode, or displays the first work desktop 42 and the second work desktop 62 in the PIP mode.

The expansion module 18 is connected to the control module 12. For example, the expansion module 18 is the universal serial bus (USB), IEEE1394 (FireWire), RS-232, general purpose interface bus (GPIB), Hewlett-Packard interface bus (HP-IB), 120, Thunderbolt, External PCIe, IDE, ATA, SATA, ATA packet interface (ATAPI), PCI or SCSI. The expansion module 18 is connected to the first host computer 4 and the second host computer 6.

The control module 12 selectively converts the displacement signal SS into a coordinate position CP, and transmits the coordinate position CP to at least one of the first host computer 4 and the second host computer 6. It is determined to switch from the first host computer 4 to the second host computer 6 by judging that the coordinate position CP falls within a first boundary coordinate range relative to the first work-desktop-boundary 422, and that the coordinate position moves from the first boundary coordinate range in the direction toward the second work desktop 62. Alternatively, it is determined to switch from the second host computer 6 to the first host computer 4 by judging that the coordinate position CP falls within a second boundary coordinate range relative to the second work-desktop-boundary 622, and that the coordinate position moves from the second boundary coordinate range in the direction toward the first work desktop 42.

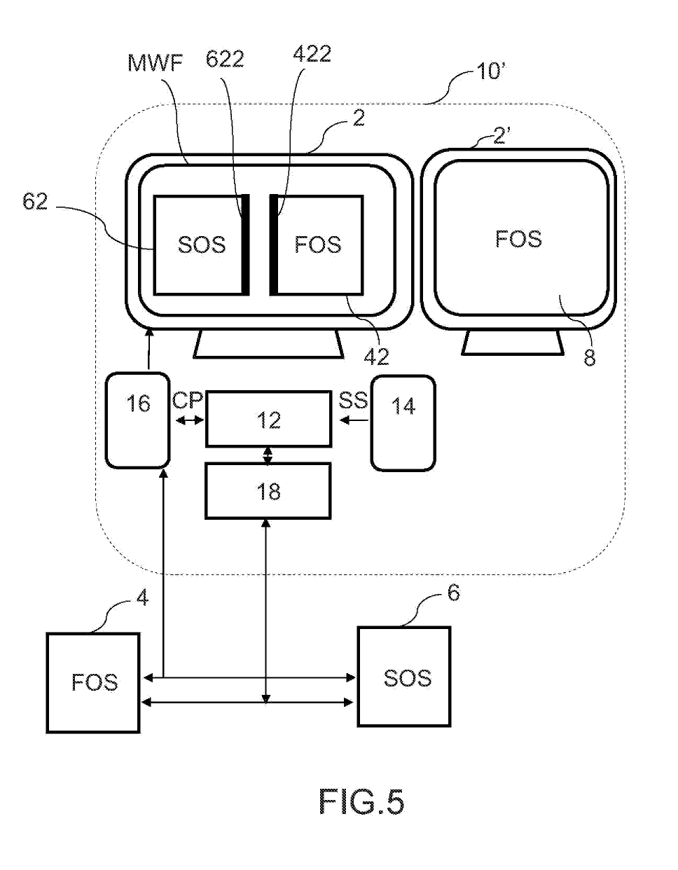

FIG. 5 is a schematic block diagram showing a seamless switching system for multiple host computers according to a fourth embodiment of the present invention. In FIG. 5, a seamless switching system 10′ for host computers comprises the control module 12, the input module 14, the image module 16 and the expansion module 18 of the third embodiment, and further comprises a first work extension desktop 8 and an extended screen unit 2′.

The first host computer 4 is operated under the first work desktop 42 and the first work extension desktop 8. The control module 12 selectively transmits the displacement signal SS to the first host computer 4 to cause movement between the first work desktop 42 and the first work extension desktop 8.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A seamless switching method for switching between a first host computer and a second host computer using an input module, a display unit and a control module, wherein the first host computer is operated under a first work desktop and the second host computer is operated under a second work desktop, the seamless switching method comprising:
(a) generating a displacement signal by the input module;
(b) converting the displacement signal into a coordinate position by the control module;
(c) displaying the first work desktop and the second work desktop by the display unit, wherein the first work desktop is located at a first direction of the second work desktop, and the second work desktop is located at a second direction of the first work desktop;
(d) positioning a relative coordinate position on the first work desktop according to the coordinate position by the first host computer, wherein the first work desktop has at least one first work-desktop-boundary;
(e) judging that the coordinate position falls within a first boundary coordinate range of the first work-desktop-boundary and that the coordinate position moves from the first boundary coordinate range in a direction toward the second work desktop to determine to switch from the first host computer to the second host computer;
(f) positioning a relative coordinate position on the second work desktop according to the coordinate position by the second host computer, wherein the second work desktop has at least one second work-desktop-boundary; and
(g) judging by the coordinate position falls within a second boundary coordinate range of the second work-desktop-boundary and by the coordinate position moves from the second boundary coordinate range in a direction toward the first work desktop to determine to switch from the second host computer to the first host computer.

2. The seamless switching method according to claim 1, wherein the first host computer is operated under the first work desktop and further operated under a first work extension desktop, the display unit displays the first work desktop, and an extended screen unit displays the first work extension desktop.

3. The seamless switching method according to claim 2, wherein in the step (b), the control module further directly causes movement on the first work desktop and the first work extension desktop according to the displacement signal.

4. The seamless switching method according to claim 1, wherein in the step (c), the display unit concurrently displays the first work desktop and the second work desktop in a picture-out-of-picture (POP) mode, or concurrently displays the first work desktop and the second work desktop in a picture-in-picture (PIP) mode, or displays the first work desktop; or the display unit the second work desktop by way of triggering.

5. A seamless switching system for multiple host computers, the seamless switching system is to be combined with a display unit to switch between a first host computer and a second host computer, wherein the first host computer is operated under a first work desktop and the second host computer is operated under a second work desktop, the first work desktop has at least one first work-desktop-boundary, and the second work desktop has at least one second work-desktop-boundary, the seamless switching system comprising:
a control module;
an input module, being connected to the control module, the input module generating a displacement signal;
an image module, being connected to the control module, the image module being connected to at least one of the display unit, the first host computer and the second host computer for making the display unit to display at least one of the first work desktop and the second work desktop; and
an expansion module, being connected to the control module, the expansion module being connected to the first host computer and the second host computer;
wherein the control module selectively converts the displacement signal into a coordinate position, and transmits the coordinate position to at least one of the first host computer and the second host computer, and the control module judges that the coordinate position falls within a first boundary coordinate range relative to the first work-desktop-boundary and that the coordinate position moves from the first boundary coordinate range in a direction toward the second work desktop to determine to switch from the first host computer to the second host computer, or the control module judges that the coordinate position falls within a second boundary coordinate range relative to the second work-desktop-boundary and that the coordinate position moves from the second boundary coordinate range in a direction toward the first work desktop to determine to switch from the second host computer to the first host computer.

6. The seamless switching method according to claim 5, further comprising a first work extension desktop and an extended screen unit, wherein the first host computer is operated under the first work desktop and the first work extension desktop, and the control module selectively transmits the displacement signal to the first host computer to cause movement between the first work desktop and the first work extension desktop.

7. The seamless switching method according to claim 5, wherein the input module is at least one of a mouse, a keyboard, a touch pen and a touch panel.

8. The seamless switching method according to claim 5, wherein the expansion module is a universal serial bus (USB), 1EEE1394 (FireWire), RS-232, general purpose interface bus (GPIB), Hewlett-Packard interface bus (HP-IB), I2C, Thunderbolt, External PCIe, IDE, ATA, SATA, ATA packet interface (ATAPI), PCI or SCSI.

9. The seamless switching method according to claim 5, wherein the image module is a high definition multimedia interface (HDMI), BNC, D-SUB, VGA, color difference terminal, S-terminal, AV terminal, DVI, D-Terminal, RCA terminal, F terminal, RF terminal, DisplayPort, Thunderbolt or Lightning bolt.

10. The seamless switching method according to claim 5, wherein the display unit concurrently displays the first work desktop in a picture-out-of-picture (POP) mode, or concurrently displays the second work desktop in a picture-in-picture (PIP) mode; or the display unit displays the first work desktop or the second work desktop by way of triggering.
